(19) United States
(12) Patent Application Publication
(10) Pub. No.: US 2021/0112130 A1
(43) Pub. Date: Apr. 15, 2021

(54) MOBILE PUSH NOTIFICATION FOR ROBOTIC PROCESS AUTOMATION (RPA)

(71) Applicant: UiPath, Inc., New York, NY (US)

(72) Inventors: Justin LeClair, New York, NY (US); Thomas Colligan, New York, NY (US)

(73) Assignee: UiPath, Inc., New York, NY (US)

(21) Appl. No.: 16/653,294

(22) Filed: Oct. 15, 2019

(51) Int. Cl. H04L 29/08; H04L 12/18; G06F 9/54; G06F 16/951

(52) U.S. Cl. CPC H04L 67/26; H04L 12/1859; G06F 2201/86; G06F 9/542; G06F 16/951; H04L 67/10

(57) ABSTRACT

A cloud server includes a transceiver configured to receive, from a push notification server, a web-hook event generated by a mobile application related to a robotic automation orchestrator and triggered by another robotic automation orchestrator. A processor is communicatively coupled with the transceiver and configured to inspect the web-hook event for duplicates, where the web-hook event is batched for notification to a device based on a predetermined timer. The transceiver is further configured to transmit, to a push notification service for delivery to the mobile application related to the robotic automation orchestrator, a single notification send request having the notification with other notifications for an event type.

### BACKGROUND

Robotic process automation (RPA) may automate repetitive operations, functions, or workflows in enterprise platforms, virtual machine (VM) configurations, remote desktops, cloud computing, desktop applications, mobile applications, or the like. When there is a failure in an application, an RPA conductor or orchestrator may desire to notify a user of the failure in an application running on a server. Such notification operation may desirable without much change to existing push notification services or servers. Rather than permitting the application to fail, user interaction may be requested.

### SUMMARY

A cloud server includes a transceiver configured to receive, from a push notification server, a web-hook event generated by a mobile application related to a robotic automation orchestrator and triggered by another robotic automation orchestrator. A processor is communicatively coupled with the transceiver and configured to inspect the web-hook event for duplicates, where the web-hook event is batched for notification to a device based on a predetermined timer. The transceiver is further configured to transmit, to a push notification service for delivery to the mobile application related to the robotic automation orchestrator, a single notification send request having the notification with other notifications for an event type.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is an illustration of robotic process automation (RPA) development, design, operation, or execution;

FIG. 1B is another illustration of RPA development, design, operation, or execution;

FIG. 10 is an illustration of a computing system or environment;

FIG. 2 is an example system diagram of providing push notifications in accordance with an example embodiment;

FIG. 3 is a flow diagram of an example method of providing a push notification in accordance with an example embodiment; and

FIG. 4 shows an example user interface (UI) in accordance with an embodiment.

### DETAILED DESCRIPTION

Although further detail is provided herein, briefly a push notification provides access directly into the area in an application where a failure occurs to allow for human interaction. The push notification may be implemented using web hooks and mobile tokens. Push notifications on mobile can enable user interaction. In this manner, when the robotic process automation (RPA) encounters an exception, instead of failing it asks for human interaction via a push notification.

The push notification comes from a service to the user device. An on-premise server may not want to send notifications directly. In this case, a push notification relay server, which may be in the cloud, sends the push notification for secure notification management. Notifications may be batched and sent as a batch to (e.g., an apple/google notification service server). If the same error occurs multiple times (e.g., a total server failure) then the errors may be combined via caching layer to enable batching. A local orchestrator may utilize the web hooks for providing the push notifications.

For the methods and processes described below the steps recited may be performed out of sequence in any order and sub-steps not explicitly described or shown may be performed. In addition, “coupled” or “operatively coupled” may mean that objects are linked but may have zero or more intermediate objects between the linked objects. Also, any combination of the disclosed features/elements may be used in one or more embodiments. When using referring to “A or B”, it may include A, B, or A and B, which may be extended similarly to longer lists. When using the notation X/Y it may include X or Y. Alternatively, when using the notation X/Y it may include X and Y. X/Y notation may be extended similarly to longer lists with the same explained logic.

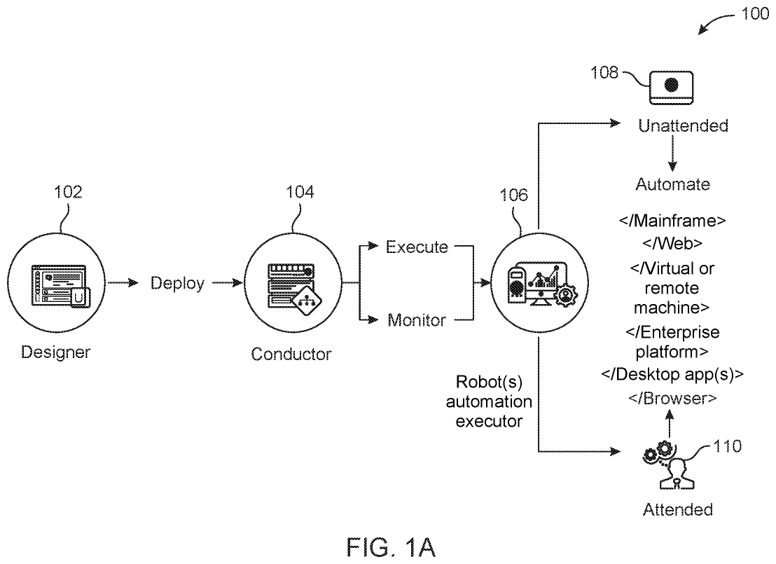

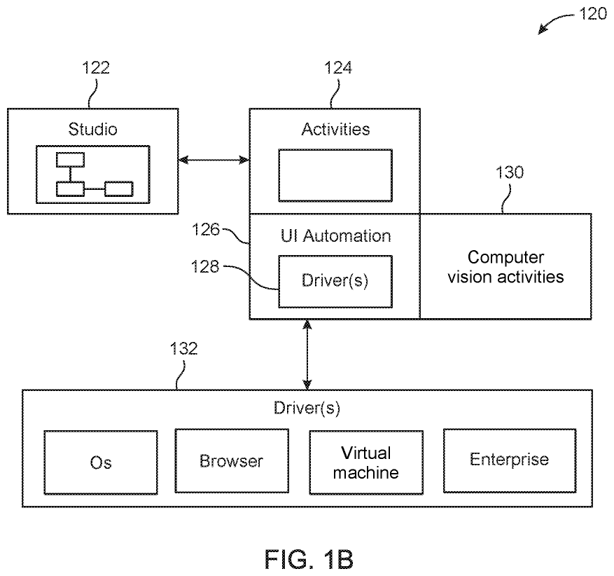

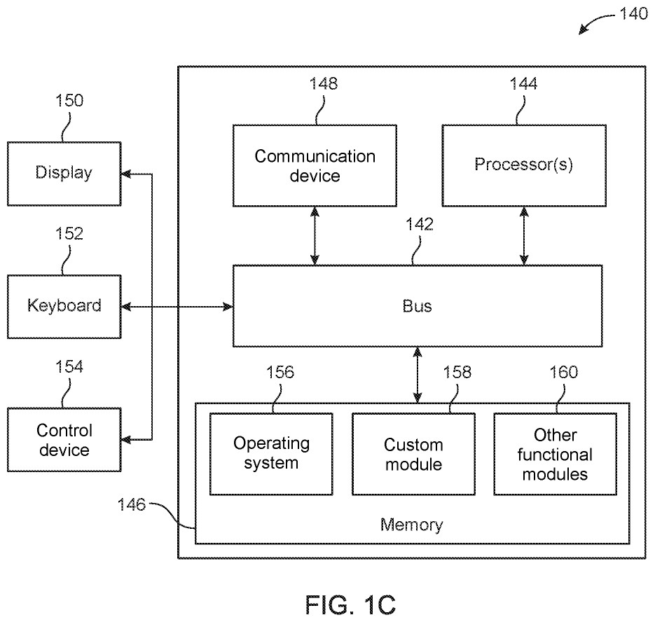

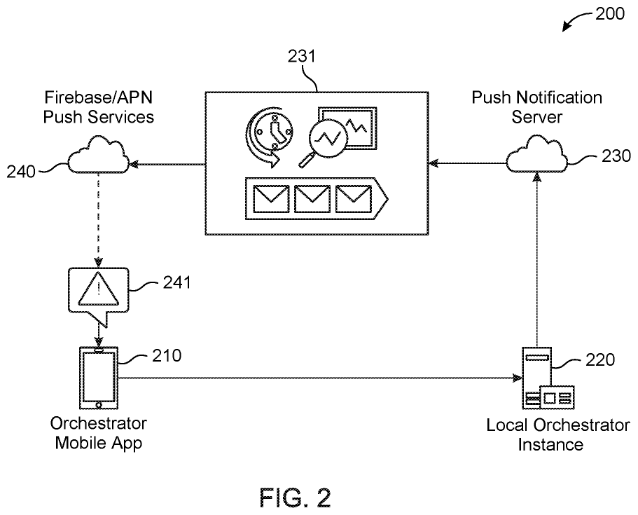

FIG. 1A is an illustration of robotic process automation (RPA) development, design, operation, or execution 100. Designer 102, sometimes referenced as a studio, development platform, development environment, or the like may be configured to generate code, instructions, commands, or the like for a robot to perform or automate one or more workflows. From a selection(s), which the computing system may provide to the robot, the robot may determine representative data of the area(s) of the visual display selected by a user or operator. As part of RPA, shapes such as squares, rectangles, circles, polygons, freeform, or the like in multiple dimensions may be utilized for UI robot development and runtime in relation to a computer vision (CV) operation or machine learning (ML) model.

Non-limiting examples of operations that may be accomplished by a workflow may be one or more of performing login, filling a form, information technology (IT) management, or the like. To run a workflow for UI automation, a robot may need to uniquely identify specific screen elements, such as buttons, checkboxes, text fields, labels, etc., regardless of application access or application development. Examples of application access may be local, virtual, remote, cloud, Citrix®, VMWare®, VNC®, Windows® remote desktop, virtual desktop infrastructure (VDI), or the like. Examples of application development may be win32, Java, Flash, hypertext markup language ((HTML), HTML5, extensible markup language (XML), Javascript, C#, C++, Silverlight, or the like.

A workflow may include, but are not limited to, task sequences, flowcharts, Finite State Machines (FSMs), global exception handlers, or the like. Task sequences may be linear processes for handling linear tasks between one or more applications or windows. Flowcharts may be configured to handle complex business logic, enabling integration of decisions and connection of activities in a more diverse manner through multiple branching logic operators. FSMs may be configured for large workflows. FSMs may use a finite number of states in their execution, which may be triggered by a condition, transition, activity, or the like. Global exception handlers may be configured to determine workflow behavior when encountering an execution error, for debugging processes, or the like.

A robot may be an application, applet, script, or the like, that may automate a UI transparent to an underlying operating system (OS) or hardware. At deployment, one or more robots may be managed, controlled, or the like by a conductor 104, sometimes referred to as an orchestrator. Conductor 104 may instruct or command robot(s) or automation executor 106 to execute or monitor a workflow in a mainframe, web, virtual machine, remote machine, virtual desktop, enterprise platform, desktop app(s), browser, or the like client, application, or program. Conductor 104 may act as a central or semi-central point to instruct or command a plurality of robots to automate a computing platform.

In certain configurations, conductor 104 may be configured for provisioning, deployment, configuration, queueing, monitoring, logging, and/or providing interconnectivity. Provisioning may include creating and maintenance of connections or communication between robot(s) or automation executor 106 and conductor 104. Deployment may include assuring the delivery of package versions to assigned robots for execution. Configuration may include maintenance and delivery of robot environments and process configurations. Queueing may include providing management of queues and queue items. Monitoring may include keeping track of robot identification data and maintaining user permissions. Logging may include storing and indexing logs to a database (e.g., an SQL database) and/or another storage mechanism (e.g., ElasticSearch®, which provides the ability to store and quickly query large datasets). Conductor 104 may provide interconnectivity by acting as the centralized point of communication for third-party solutions and/or applications.

Robot(s) or automation executor 106 may be configured as unattended 108 or attended 110. For unattended 108 operations, automation may be performed without third party inputs or control. For attended 110 operation, automation may be performed by receiving input, commands, instructions, guidance, or the like from a third party component.

A robot(s) or automation executor 106 may be execution agents that run workflows built in designer 102. A commercial example of a robot(s) for UI or software automation is UiPath Robots™. In some embodiments, robot(s) or automation executor 106 may install the Microsoft Windows® Service Control Manager (SCM)-managed service by default. As a result, such robots can open interactive Windows® sessions under the local system account, and have the rights of a Windows® service.

In some embodiments, robot(s) or automation executor 106 may be installed in a user mode. These robots may have the same rights as the user under which a given robot is installed. This feature may also be available for High Density (HD) robots, which ensure full utilization of each machine at maximum performance such as in an HD environment.

In certain configurations, robot(s) or automation executor 106 may be split, distributed, or the like into several components, each being dedicated to a particular automation task or activity. Robot components may include SCM-managed robot services, user mode robot services, executors, agents, command line, or the like. SCM-managed robot services may manage or monitor Windows® sessions and act as a proxy between conductor 104 and the execution hosts (i.e., the computing systems on which robot(s) or automation executor 106 is executed). These services may be trusted with and manage the credentials for robot(s) or automation executor 106.

User mode robot services may manage and monitor Windows® sessions and act as a proxy between conductor 104 and the execution hosts. User mode robot services may be trusted with and manage the credentials for robots. A Windows® application may automatically be launched if the SCM-managed robot service is not installed.

Executors may run given jobs under a Windows® session (i.e., they may execute workflows). Executors may be aware of per-monitor dots per inch (DPI) settings. Agents may be Windows® Presentation Foundation (WPF) applications that display available jobs in the system tray window. Agents may be a client of the service. Agents may request to start or stop jobs and change settings. The command line may be a client of the service. The command line is a console application that can request to start jobs and waits for their output.

In configurations where components of robot(s) or automation executor 106 are split as explained above helps developers, support users, and computing systems more easily run, identify, and track execution by each component. Special behaviors may be configured per component this way, such as setting up different firewall rules for the executor and the service. An executor may be aware of DPI settings per monitor in some embodiments. As a result, workflows may be executed at any DPI, regardless of the configuration of the computing system on which they were created. Projects from designer 102 may also be independent of browser zoom level. For applications that are DPI-unaware or intentionally marked as unaware, DPI may be disabled in some embodiments.

FIG. 1B is another illustration of RPA development, design, operation, or execution 120. A studio component or module 122 may be configured to generate code, instructions, commands, or the like for a robot to perform one or more activities 124. User interface (UI) automation 126 may be performed by a robot on a client using one or more driver(s) components 128. A robot may perform activities using computer vision (CV) activities module or engine 130. Other drivers 132 may be utilized for UI automation by a robot to get elements of a UI. They may include OS drivers, browser drivers, virtual machine drivers, enterprise drivers, or the like. In certain configurations, CV activities module or engine 130 may be a driver used for UI automation.

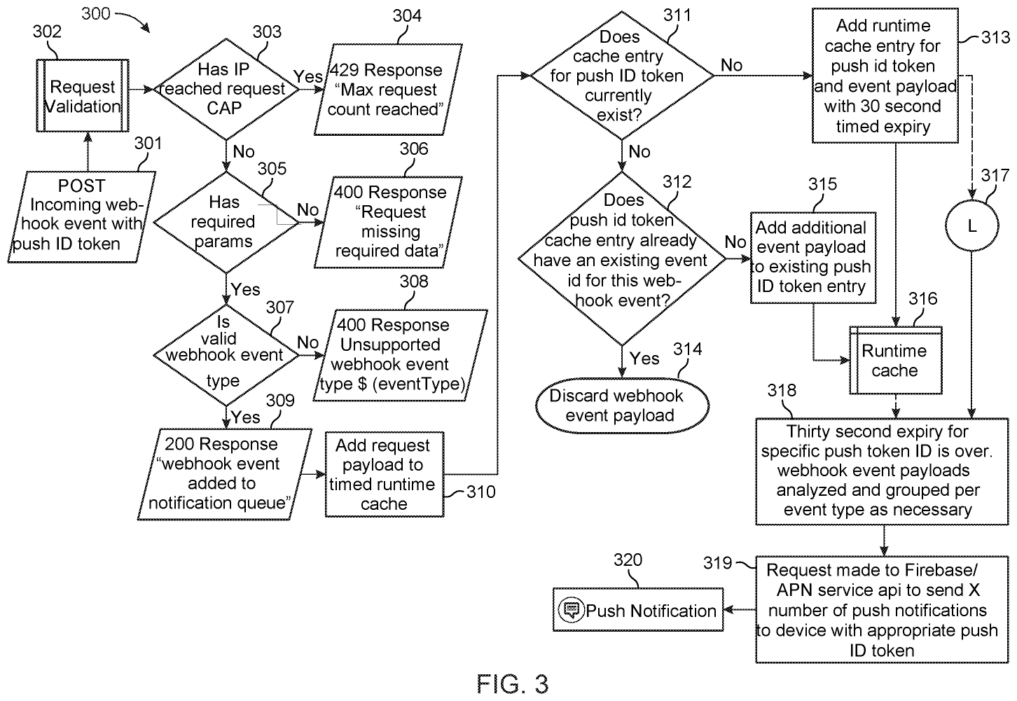

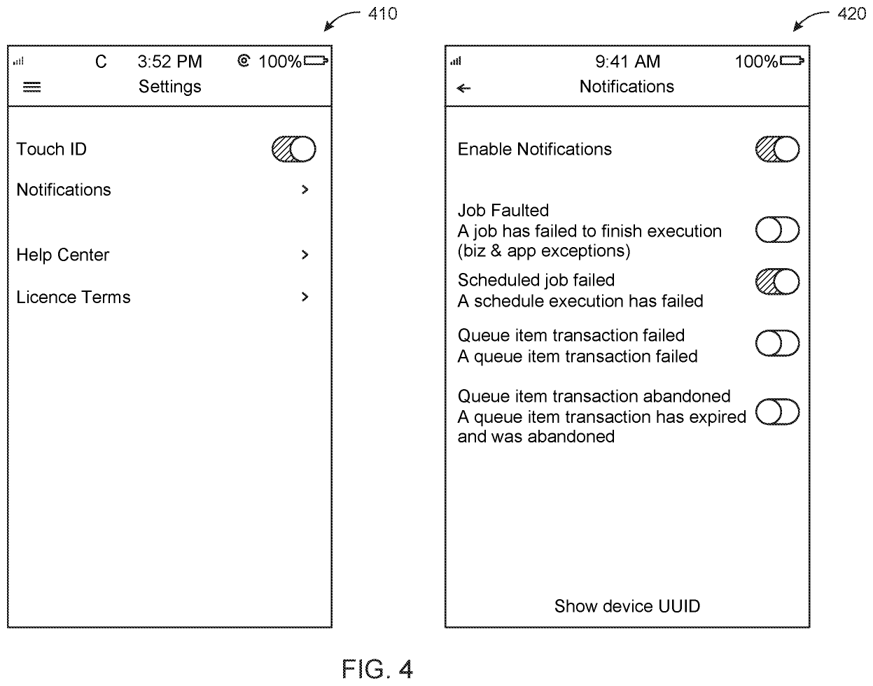

FIG. 10 is an illustration of a computing system or environment 140 that may include a bus 142 or other communication mechanism for communicating information or data, and one or more processor(s) 144 coupled to bus 142 for processing. One or more processor(s) 144 may be any type of general or specific purpose processor, including a central processing unit (CPU), application specific integrated circuit (ASIC), field programmable gate array (FPGA), graphics processing unit (GPU), controller, multi-core processing unit, three dimensional processor, quantum computing device, or any combination thereof. One or more processor(s) 144 may also have multiple processing cores, and at least some of the cores may be configured to perform specific functions. Multi-parallel processing may also be configured. In addition, at least one or more processor(s) 144 may be a neuromorphic circuit that includes processing elements that mimic biological neurons.

Memory 146 may be configured to store information, instructions, commands, or data to be executed or processed by processor(s) 144. Memory 146 can be comprised of any combination of random access memory (RAM), read only memory (ROM), flash memory, solid-state memory, cache, static storage such as a magnetic or optical disk, or any other types of non-transitory computer-readable media or combinations thereof. Non-transitory computer-readable media may be any media that can be accessed by processor(s) 144 and may include volatile media, non-volatile media, or the like. The media may also be removable, non-removable, or the like.

Communication device 148, may be configured as a frequency division multiple access (FDMA), single carrier FDMA (SC-FDMA), time division multiple access (TDMA), code division multiple access (CDMA), orthogonal frequency-division multiplexing (OFDM), orthogonal frequency-division multiple access (OFDMA), Global System for Mobile (GSM) communications, general packet radio service (GPRS), universal mobile telecommunications system (UMTS), cdma2000, wideband CDMA (W-CDMA), high-speed downlink packet access (HSDPA), high-speed uplink packet access (HSUPA), high-speed packet access (HSPA), long term evolution (LTE), LTE Advanced (LTE-A), 802.11x, Wi-Fi, Zigbee, Ultra-WideBand (UWB), 802.16x, 802.15, home Node-B (HnB), Bluetooth, radio frequency identification (RFID), infrared data association (IrDA), near-field communications (NFC), fifth generation (5G), new radio (NR), or any other wireless or wired device/transceiver for communication via one or more antennas. Antennas may be singular, arrayed, phased, switched, beamforming, beamsteering, or the like.

One or more processor(s) 144 may be further coupled via bus 142 to a display device 150, such as a plasma, liquid crystal display (LCD), light emitting diode (LED), field emission display (FED), organic light emitting diode (OLED), flexible OLED, flexible substrate displays, a projection display, 4K display, high definition (HD) display, a Retina© display, in-plane switching (IPS) or the like based display. Display device 150 may be configured as a touch, three dimensional (3D) touch, multi-input touch, or multi-touch display using resistive, capacitive, surface-acoustic wave (SAW) capacitive, infrared, optical imaging, dispersive signal technology, acoustic pulse recognition, frustrated total internal reflection, or the like as understood by one of ordinary skill in the art for input/output (I/O).

A keyboard 152 and a control device 154, such as a computer mouse, touchpad, or the like, may be further coupled to bus 142 for input to computing system or environment 140. In addition, input may be provided to computing system or environment 140 remotely via another computing system in communication therewith, or computing system or environment 140 may operate autonomously.

Memory 146 may store software components, modules, engines, or the like that provide functionality when executed or processed by one or more processor(s) 144. This may include an OS 156 for computing system or environment 140. Modules may further include a custom module 158 to perform application specific processes or derivatives thereof. Computing system or environment 140 may include one or more additional functional modules 160 that include additional functionality.

Computing system or environment 140 may be adapted or configured to perform as a server, an embedded computing system, a personal computer, a console, a personal digital assistant (PDA), a cell phone, a tablet computing device, a quantum computing device, cloud computing device, a mobile device, a fixed mobile device, a smart display, a wearable computer, or the like.

FIG. 2 is an example system 200 diagram of providing push notifications in accordance with an embodiment. The system 200 includes orchestrator mobile application device 210, a local orchestrator 220, a push notification server 230 performing functionality 231 as a cloud server, and a firebase APN/push services 240. The orchestrator mobile application device 210 creates a webhook pointing to a cloud notification server that is sent to the local orchestrator 220. The local orchestrator 230 institutes webhook triggers (e.g., job faulted, schedule faulted, queue transaction failure, queue transaction abandoned). These are provided as events to the push notification server 230. The push notification server 230 inspects incoming events for duplicates and discards duplicate events. Notifications that are for specific devices are batched together by the push notification server. A timer may be set by the push notification server until batching of notifications is processed. Multiple notifications for a single event type are grouped into one notification send request. The push services are received by the push notification server 230 as webhook events via a POST request and are pushed through the firebase/APN push services 240. The firebase/APN push services 240 push a push notification 241 to the orchestrator mobile application device 210.

Further detail relating to the functionality 231 of the push notification server/cloud server 230 is provided herein. The push notification server/cloud server 230 receives incoming webhook events from the orchestrator 220, and using that information, sends out push notifications to the orchestrator mobile application device 210. The push notification server/cloud server 230 may not contain any database or on disk cache of information. All information may be cached to run-time memory, which is periodically flushed. Logs are used and saved to disk to keep track of server events, but none of the webhook payload information is logged on the server. The only incoming data that is logged is the user's anonymous push token ID, and what type of incoming webhook event was processed.

Since the push notification server/cloud server 230 potentially receives a number of webhook events in a small period of time, it carefully parses and queues the incoming webhook events to make sure not to overload the Orchestrator Mobile application device 210 with a massive amount of push notifications during certain events.

There are a number of fields in the incoming webhook events that may be utilized to queue these notifications effectively (e.g., Push Id Token—Identifies what mobile device the event is intended for. Type—The event type *(job.faulted, schedule.failed, etc. . . . )*, Event Id—Unique identifier assigned to every event when it was created).

Any incoming events with duplicate event Ids are discarded by the server as mentioned above. There is a chance of this happening when a webhook event is triggered and the orchestrator 220 attempts send the webhook event. It may not realize that the event successfully reached the server, and attempt to send the same event again.

The queue cycle on the cloud server may be set to an interval, (e.g., 15 or 30 seconds). This means that if 12 different jobs fault for a single user within the interval, all of the job fault events are batched together and sent as a single notification to the mobile user stating something to the effect of “There were 12 job failures”. The goal is to batch send multiple events of the same type as a single notification to the user. This is to prevent a flood of incoming push notifications being sent to the user at once.

A run-time in-memory only cache is used during the interval to group notifications together. After the notification is sent all data related to the notification is purged from run-time memory. The memory-cache library to achieve this in-memory timed caching system may be utilized for this purpose. The interval is triggered on a per push ID token basis. As soon as a valid webhook event is sent to the server, the payload for that event is added to the run time memory cache with an expiration timer mapped to the push ID token. Any additional webhook events meant for that same push id token are added onto that same entry, while the time continues to count down. After the full one minute has passed, all webhook event payloads are then processed, grouped, and then sent for said user.

The user's push ID token, and event type, on incoming requests are logged to disk for debugging purposes. The rest of the information sent up with the webhook event is not currently logged.

When a valid incoming webhook event request is made, a request count is incremented and mapped to an identifier made up of the client IP address and tenant name that made the request. The client IP in this case would be the local orchestrator 220 instance where the event was triggered and the tenant name would be the tenant that the request was triggered on. The current rate limit may be set to a maximum number of requests within a rolling interval. The goal of this IP address with tenant name rate limiting is to ensure that no single orchestrator instance tenant can queue up too many event notifications at once. Having the tenant name combined with the IP to create the identifier avoids the issue of having one tenant on any orchestrator instance monopolize the request count.

FIG. 3 is a flow diagram of an example method 300 of providing a push notification in accordance with an example embodiment. In step 301, an incoming webhook event is received with the Push ID token. The request is validated (step 302) and it is determined if the IP has reached the request cap (step 303). If the cap is reached, a “max request count reached” response is generated (step 304).

If the cap is not reach in step 303, it is determined if the required parameters are present (step 305). If not, in step 306 a response to “request missing required data” is generated. If the required parameters are present in step 305, then it is determined if there is a valid webhook type (step 307). If there is not a valid webhook type in step 307, then the method proceeds to step 308 where “unsupported webhook type” response is generated.

If there is a valid webhook type in step 307, the “webhook event added to Notification Queue” is generated in step 309. From there, the payload request is added to the runtime cache (step 310). It is then determined whether the cache entry for the push ID token currently exists (step 311). If it does, then the method proceeds to step 312 where it is determined if the push ID token cache entry has an existing event ID for the webhook event.

Otherwise, if the answer in step 311 is that it does not then the method proceeds to step 313 where the runtime cache entry for the push ID token is added and an event payload with a timed expiry (e.g., 30 seconds) (e.g., clock 317), and proceeds to step 316 which stores the information in a runtime cache.

If in step 312 it is determined that the push ID token cache entry has an existing event ID for the webhook event, the webhook event payload is discarded (step 314). Otherwise, the method proceeds to step 315, where an additional event payload is added to the existing push ID token entry. The method then proceeds to step 316 as described above, and to step 318 where the webhook event are analyzed and grouped per event type as necessary once the timer for a specific push token ID is expired (e.g., 30 second timer).

A request is then made to the firebase APN/push services to send X number of push notifications to the orchestrator mobile app device with the appropriate push ID tokens (step 319). The push notifications are sent in step 320.

The mobile application on the device 240 checks to ensure that the user has all relevant webhook permissions to manage notifications via webhooks (e.g. view, create, edit, and delete). If any of these permissions are missing, an alert is displayed to the user indicating that they ask their system administrator to enable webhook permissions for their account in-order to use the push notifications feature. The mobile application fetches its current push id token from Firebase and makes a GET request to the webhook REST API in-order to retrieve the list of all the current web-hooks listed on the tenant.

Every URL is checked to see if it contains a matching device UUID in each of the existing webhooks URLs. Every URL that contained a matching device UUID is checked to see if it also contains a matching push id token. Every URL that does not contain a matching push id token is deleted via the webhook REST Api (these urls would exist if the user un-installed and re-installed the application, since the push id tokens change on a per app instance basis).

If a URL with a matching device UUID and matching push id token is found, the Notifications: On toggle is automatically set to on and configured to whatever events that web-hook was already set to.

FIG. 4 shows an example user interface (UI) in accordance with an embodiment. Screen 410 shows an example setting screen and Screen 420 shows an example notification setting screen.

The method 300 may utilize various security based protocols and technologies (e.g., TLS, Helmet, and Azure Store Encryption) that the push notification server leverages to protect its content and processes.

In the examples given herein, modules may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may be at least partially implemented in software for execution by various types of processors. An identified unit of executable code may include one or more physical or logical blocks of computer instructions that may, for instance, be organized as an object, procedure, routine, subroutine, or function. Executables of an identified module co-located or stored in different locations such that, when joined logically together, comprise the module.

A module of executable code may be a single instruction, one or more data structures, one or more data sets, a plurality of instructions, or the like distributed over several different code segments, among different programs, across several memory devices, or the like. Operational or functional data may be identified and illustrated herein within modules, and may be embodied in a suitable form and organized within any suitable type of data structure.

In the examples given herein, a computer program may be configured in hardware, software, or a hybrid implementation. The computer program may be composed of modules that are in operative communication with one another, and to pass information or instructions.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1. A cloud server comprising:
a transceiver configured to receive a webhook event, wherein a webhook of the received webhook event was generated by a mobile application related to an orchestrator for robotic automation and wherein the received webhook event is triggered by the orchestrator; and
a processor communicatively coupled with the transceiver, the processor configured to inspect the received webhook event for duplicates, where the received webhook event is batched for notification to a device based on a predetermined timer,
wherein the transceiver is further configured to transmit, to a push notification service for delivery to the mobile application related to the orchestrator, a single notification send request having the notification with other notifications for an event type.

2. The cloud server of claim 1 wherein the received webhook event includes one or more of a job faulted event, a schedule faulted event, a queue transaction failure event, or a queue transaction abandoned event.

3. The cloud server of claim 2 wherein the processor is further configured to discard duplicate webhook events.

4. The cloud server of claim 1 wherein the processor is further configured to set the timer until batching of notifications is processed.

5. The cloud server of claim 1 wherein information received by the cloud server is cached to run-time memory.

6. The cloud server of claim 1 wherein the processor purges all data related to the notification from the run-time memory upon sending of the notification.

7. The cloud server of claim 1 wherein the processor is configured to queue notifications.

8. The cloud server of claim 7 wherein the queuing is based on one or more of a push ID token that identifies a mobile device the event is intended for, an event type, and an event ID that identifies an event.

9. The cloud server of claim 1 wherein the processor sets a maximum number of requests from the orchestrator.

10. A method of providing push notifications, implemented in a cloud server, the method comprising:
receiving, by a transceiver of the cloud server, a webhook event, wherein a webhook of the received webhook event was generated by a mobile application related to an orchestrator for robotic automation and wherein the received webhook event is triggered by the orchestrator;
inspecting, by a processor of the cloud server, the received webhook event for duplicates, where the received webhook event is batched for notification to a device based on a predetermined timer; and
transmitting, by the transceiver of the cloud server, to a push notification service for delivery to the mobile application related to the orchestrator, a single notification send request having the notification with other notifications for an event type.

11. The method of claim 10 wherein the received webhook event includes one or more of a job faulted event, a schedule faulted event, a queue transaction failure event, or a queue transaction abandoned event.

12. The method of claim 11, further comprising discarding, by the processor, duplicate webhook events.

13. The method of claim 10, further comprising setting, by the processor, the timer until batching of notifications is processed.

14. The method of claim 10, further comprising caching information received by the cloud server to run-time memory.

15. The method of claim 10, further comprising purging, by the processor, all data related to the notification from the run-time memory upon sending of the notification.

16. The method of claim 10, further comprising queueing notifications by the processor.

17. The method of claim 16 wherein the queuing is based on one or more of a push ID token that identifies a mobile device the event is intended for, an event type, and an event ID that identifies an event.

18. The method of claim 10, further comprising setting, by the processor a maximum number of requests from the orchestrator.

19. A non-transitory computer-readable medium for providing push notifications in a computer system, the non-transitory computer-readable medium having instructions recorded thereon, that when executed by a processor, cause the processor to perform operations including:
receiving, from a transceiver operatively coupled with the processor, a webhook event, wherein a webhook of the received webhook event was generated by a mobile application related to an orchestrator for robotic automation and wherein the received webhook event is triggered by the orchestrator;
inspecting, by the processor, the received webhook event for duplicates, where the received webhook event is batched for notification to a device based on a predetermined timer; and
causing the transceiver to transmit, to a push notification service for delivery to the mobile application related to the orchestrator, a single notification send request having the notification with other notifications for an event type.

20. The non-transitory computer-readable medium of claim 19 wherein the received webhook event includes one or more of a job faulted event, a schedule faulted event, a queue transaction failure event, or a queue transaction abandoned event.
